(19) United States
(12) Patent Application Publication
(10) Pub. No.: US 2026/0119065 A1
(43) Pub. Date: Apr. 30, 2026

(54) STORAGE OPTIMIZATION VIA DATA DEDUPLICATION

(71) Applicant: Dell Products L.P., Round Rock, TX (US)

(72) Inventors: Tal ZOHAR, Tel Aviv (IL); Uri SHABI, Tel Mond (IL); Amit ZAITMAN, Shavey Shomron (IL)

(21) Appl. No.: 18/933,236

(22) Filed: Oct. 31, 2024

(51) Int. Cl. G06F 3/06

(52) U.S. Cl. CPC G06F 3/0641; G06F 3/0608; G06F 3/0673

(57) ABSTRACT

In some implementations, a storage device may detect partial similarity between a candidate storage page and a target storage page using an XOR operation on the candidate storage page and the target storage page. The storage device may generate a data structure indicative of the partial similarity. The storage device may store the data structure with a pointer to the target storage page. The storage device may receive a read command associated with the candidate storage page. The storage device may reconstruct, in response to the read command, the candidate storage page based on the data structure and the pointer.

### BACKGROUND

Data deduplication generally includes identification and removal of duplicate data. Data deduplication improves management of storage resources by reducing overhead and increases overall system performance by reducing physical wear on storage systems.

### SUMMARY

Some implementations described herein relate to a method. The method may include detecting, by a storage device, partial similarity between a candidate storage page and a target storage page using an XOR operation on the candidate storage page and the target storage page. The method may include generating, by the storage device, a data structure indicative of the partial similarity. The method may include storing, by the storage device, the data structure with a pointer to the target storage page. The method may include receiving, by the storage device, a read command associated with the candidate storage page. The method may include reconstructing, by the storage device and in response to the read command, the candidate storage page based on the data structure and the pointer.

Some implementations described herein relate to a device that includes one or more processors. The one or more processors may be configured to calculate a hash value for a candidate page to be stored. The one or more processors may be configured to compare the hash value of the candidate page with a set of hash values of a set of stored pages to identify a target page within the set of stored pages. The one or more processors may be configured to perform a set of XOR operations on the target page and one or more neighboring pages, relative to the candidate page, to determine a set of XOR results. The one or more processors may be configured to store a selected XOR result, from the set of XOR results, based on a similarity threshold. The one or more processors may be configured to store a pointer to a selected page, from the target page and the one or more neighboring pages, with the selected XOR result.

Some implementations described herein relate to a non-transitory computer-readable medium that stores a set of instructions. The set of instructions, when executed by one or more processors of a device, may cause the device to perform a set of comparison operations between a set of target storage pages and a candidate storage page to determine a set of comparison results. The set of instructions, when executed by one or more processors of the device, may cause the device to select a best target storage page, from the set of target storage pages, using the set of comparison results. The set of instructions, when executed by one or more processors of the device, may cause the device to compress and store a comparison result, from the set of comparison results, corresponding to the best target storage page. The set of instructions, when executed by one or more processors of the device, may cause the device to store a pointer to the best target storage page to enable reconstruction of the candidate storage page during read operations.

### BRIEF DESCRIPTION OF THE DRAWINGS

FIGS. 1A-1C are diagrams of an example implementation relating to storage optimization via data deduplication, in accordance with some embodiments of the present disclosure.

FIGS. 2A-2B are diagrams of an example implementation relating to storage optimization via data deduplication, in accordance with some embodiments of the present disclosure.

FIG. 3 is a diagram of an example iterative process relating to storage optimization via data deduplication, in accordance with some embodiments of the present disclosure.

FIG. 4 is a diagram of an example environment in which systems and/or methods described herein may be implemented, in accordance with some embodiments of the present disclosure.

FIG. 5 is a diagram of example components of one or more devices of FIG. 4, in accordance with some embodiments of the present disclosure.

FIG. 6 is a flowchart of an example process relating to storage optimization via data deduplication, in accordance with some embodiments of the present disclosure.

### DETAILED DESCRIPTION

The following detailed description of example implementations refers to the accompanying drawings. The same reference numbers in different drawings may identify the same or similar elements.

Data deduplication helps to optimize storage utilization by reducing redundancy across stored data. Generally, deduplication involves dividing stored data into fixed-size blocks (also referred to as “pages”) and comparing pages using hash values. When a duplicate hash value is detected, a reference to the already-stored page is created in lieu of saving another copy of the page, thereby conserving space. However, identifying and eliminating entirely identical pages provides limited improvements in space management.

Improving data deduplication by enabling detection and use of partial similarities improves optimization of storage space. Some implementations described herein enable comparison of a candidate page and a target page (e.g., using an XOR operation) in order to encode a data structure based on partial similarity between the pages. For example, the target page may be selected based on a quantity of zero areas in results of the XOR operation satisfying a similarity threshold. As a result, memory overhead is reduced by storing a comparison result in lieu of a full copy of the candidate page. The similarity threshold may be selected to balance additional computational costs of reconstructing the candidate page (e.g., in response to a read command) with conservation of memory space.

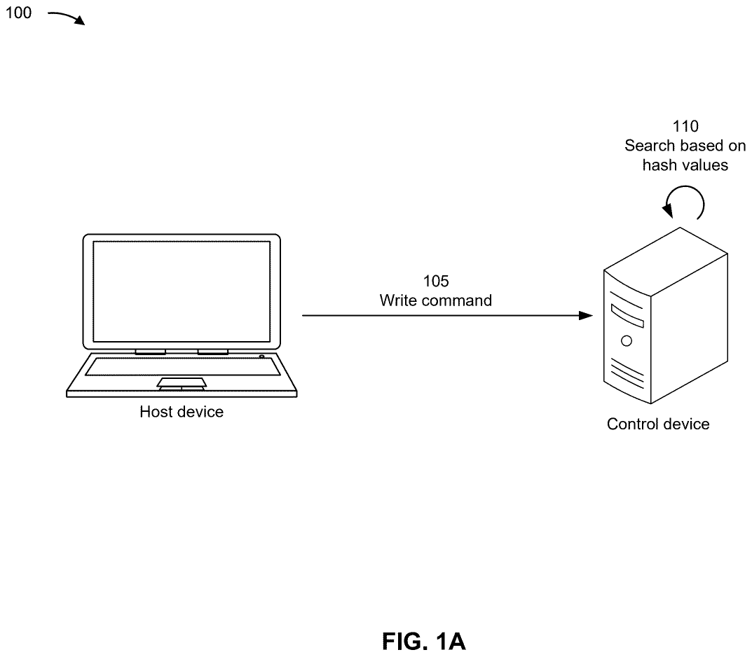

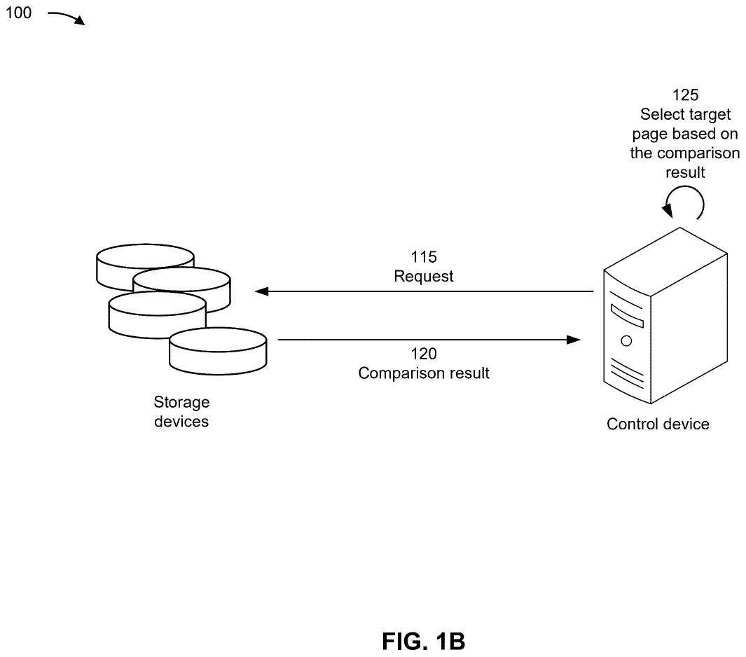

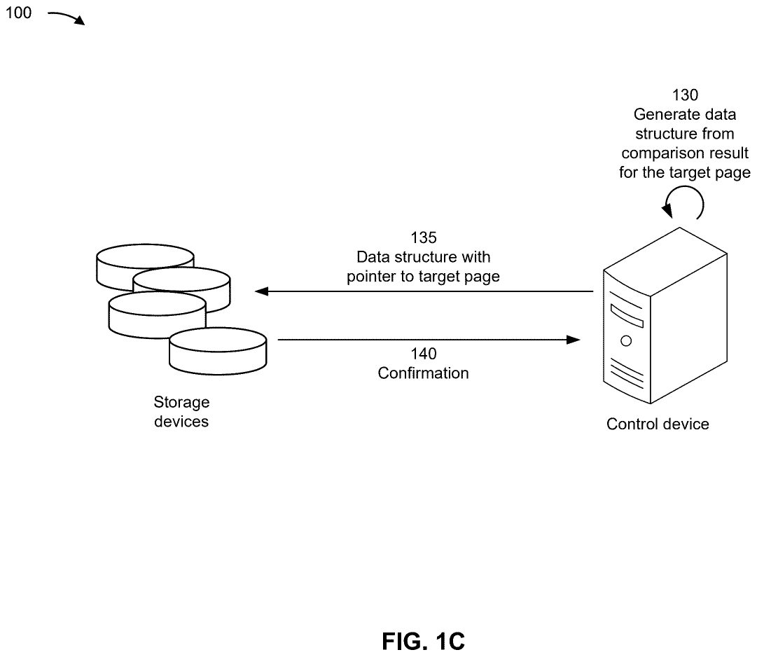

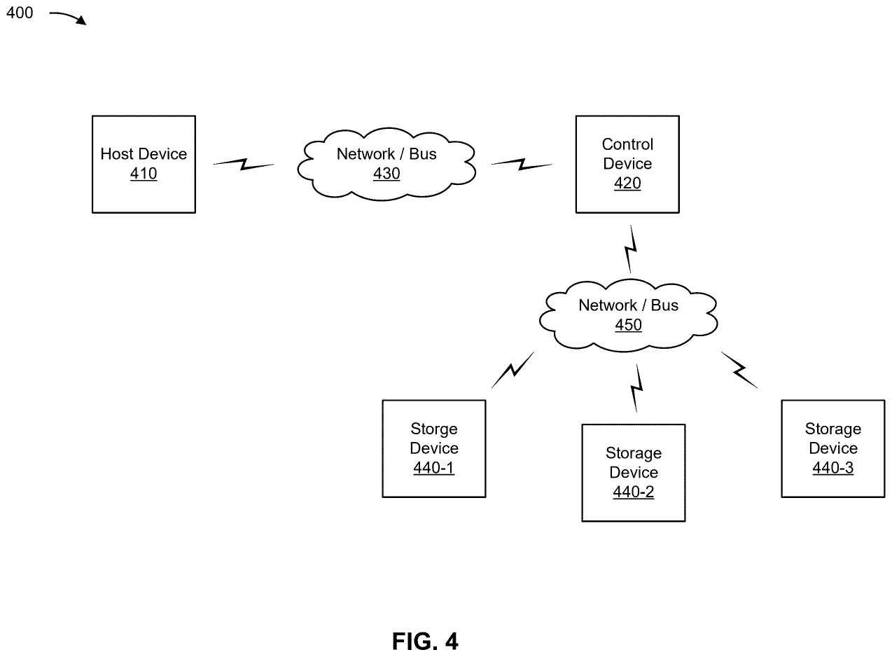

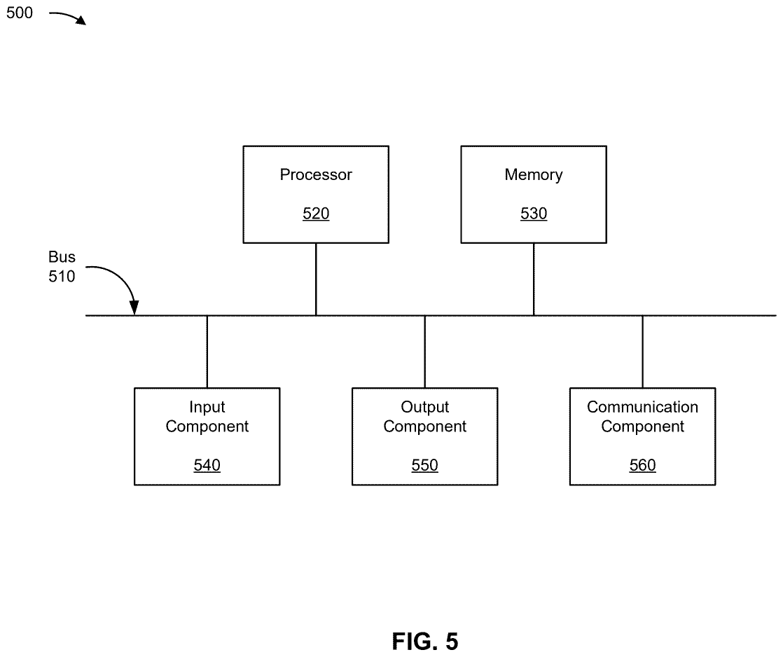

FIGS. 1A-1C are diagrams of an example 100 associated with storage optimization via data deduplication. As shown in FIGS. 1A-1C, example 100 includes a host device, a control device, and a set of storage devices. These devices are described in more detail in connection with FIGS. 4 and 5.

As shown in FIG. 1A and by reference number 105, the host device may transmit, and the control device may receive, a write command. The write command may include (or at least indicate) a candidate page for storage (on the set of storage devices). In some implementations, the host device may transmit the write command in response to input from a user. For example, the user may save a file, move a file, and/or copy-and-paste a file, among other examples. Therefore, the candidate page may represent file operations requested by the user. Additionally, or alternatively, the host device may transmit the write command automatically. For example, the host device may be configured to automatically generate backups. Therefore, the candidate page may represent backup operations and/or other automatic operations performed by the host device.

As shown by reference number 110, the control device may search for a target page. The target page may be selected from a set of possible pages already stored on the set of storage devices. Accordingly, although FIG. 1A depicts the search operation as limited to the control device, other examples may include the control device communicating with the set of storage devices to search for the target page.

As further shown by reference number 110, the control device may search using hash values. For example, the control device may calculate a hash value of the candidate page. The control device may select the target page using the hash value of the candidate page. For example, the control device may calculate a hash value of the target page and may compare the hash value of the candidate page with the hash value of the target page. Accordingly, the control device may identify the target page based on the hash value of the target storage page matching the hash value of the candidate storage page. As used herein, “match” may refer to a perfect match or to a fuzzy match (e.g., a proportion of one hash value matches another hash value, where the proportion satisfies a match threshold).

The control device may begin with a possible page closest (e.g., in time and/or space) to the candidate page and proceed to calculate and compare hash values of neighboring pages if the possible page closest to the candidate page is not selected as the target page. Therefore, the control device may compare the hash value of the candidate page with a set of hash values of a set of stored pages (that is, the set of possible pages) to identify a target page within the set of stored pages.

Although the example 100 describes the control device as separate (e.g., logically, virtually, and/or physically) from the set of storage devices, other examples may have the control device at least partially integrated with the set of storage devices. Accordingly, the integrated system may be referred to as a “storage system” or a “storage device.”

As shown in FIG. 1B, the control device may detect partial similarity between the candidate page and the target page. Although FIG. 1B depicts the detection operation as including the set of storage devices, other examples may include the control device performing the detection independently (e.g., using a cached or retrieved version of the target page). As shown by reference number 115, the control device may transmit, and the set of storage devices may receive, a request for a comparison operation (between the candidate page and the target page). For example, the control device may transmit, and the set of storage devices may receive, the request using an application programming interface (API) provided by the set of storage devices and/or a driver that controls the set of storage devices.

In some implementations, the comparison operation may include an XOR operation (on the candidate page and the target page). Accordingly, the control device may use the XOR operation to detect partial similarity between the candidate page and the target page. In some implementations, the XOR operation may be performed at a block level. Performing the XOR operation at the block level conserves power and processing resources as compared with more granular XOR operations. Additionally, performing the XOR operation at the block level provides a higher-level comparison; as a result, the control device may select the target page with greater similarity, which avoids marginal compression, as described above.

As shown by reference number 120, the set of storage devices may transmit, and the control device may receive, a comparison result in response to the request. The comparison result may be a result of the XOR operation (also referred to as an “XOR result”). In one example, the control device may determine that a quantity of zero areas in the comparison result satisfies a similarity threshold. Therefore, as shown by reference number 125, the control device may select the target page based on the comparison result (e.g., in response to the comparison result satisfying the similarity threshold).

The similarity threshold may be selected based on one or more properties of the set of storage devices (also referred to collectively as a “storage system”). For example, the similarity threshold may be lowered in response to higher processing and retrieval rates (e.g., such that increased computational costs may be absorbed). In another example, the similarity threshold may be increased in response to larger available storage space (e.g., such that small space gains are not worthwhile). The similarity threshold may be preconfigured (e.g., selected during manufacture and/or setup of the storage system, among other examples) or may be dynamic (e.g., modified by the storage system according to available space and processing resources, among other examples).

Although FIG. 1A is described in connection with selecting a single target page and FIG. 1B is described in connection with confirming selection of the target page, other examples may differ. In one example, the control device may use the operations described in connection with FIG. 1A to select a set of target pages. For example, the control device may select the set of target pages using at least one hash value for at least one target page in the set of target pages. Accordingly, the control device may use the operations described in connection with FIG. 1B to select a best target page from the set of target pages. For example, the control device may (with the set of storage devices) perform a set of comparison operations, between the set of target pages and the candidate page, to determine a set of comparison results, and the control device may select the best target page, from the set of target pages, using the set of comparison results (e.g., based on the comparison result corresponding to the best storage page satisfying the similarity threshold, as described above).

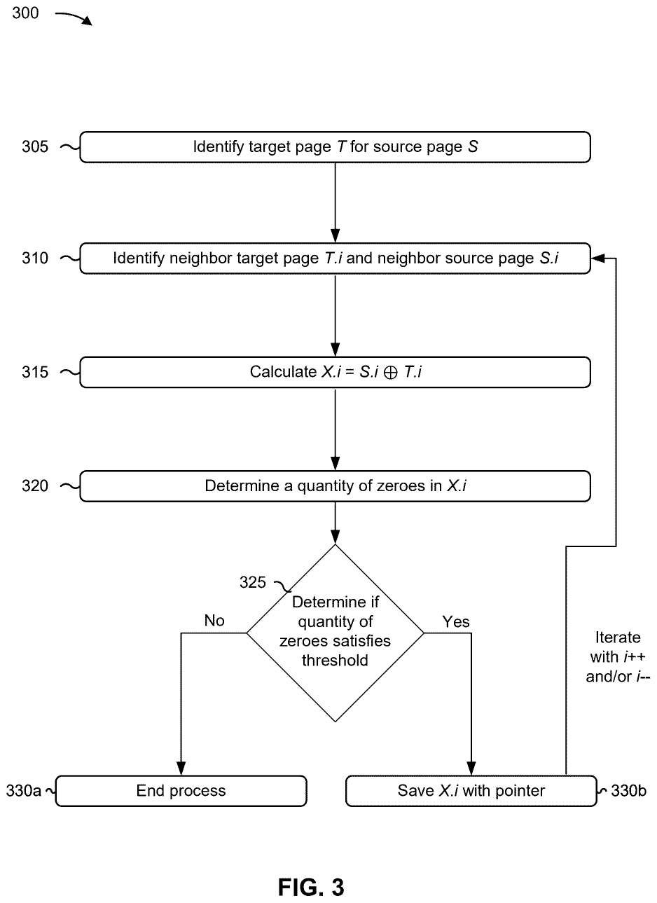

Similarly, the control device may use an iterative process (e.g., as described in connection with FIG. 3) to continue selecting new target pages (e.g., by identifying neighbors to the target page) and new candidate pages (e.g., by identifying neighbors to the candidate page). Accordingly, the control device may use comparison results (e.g., XOR results) to continue matching target pages to candidate pages (e.g., until the similarity threshold fails to be satisfied).

In another example, the control device may refrain from using hash values as described in connection with FIG. 1A and proceed directly to a set of comparison operations (e.g., a set of XOR operations, as described in connection with FIG. 1B). For example, the control device may perform the set of comparison operations on a set of neighboring pages (e.g., in time and/or space) relative to the candidate page.

As shown in FIG. 1C and by reference number 130, the control device may generate a data structure indicative of the partial similarity. For example, the data structure may encode the comparison result (e.g., the XOR result) described in connection with FIG. 1B. In some implementations, the control device may compress the comparison result in order to generate the data structure.

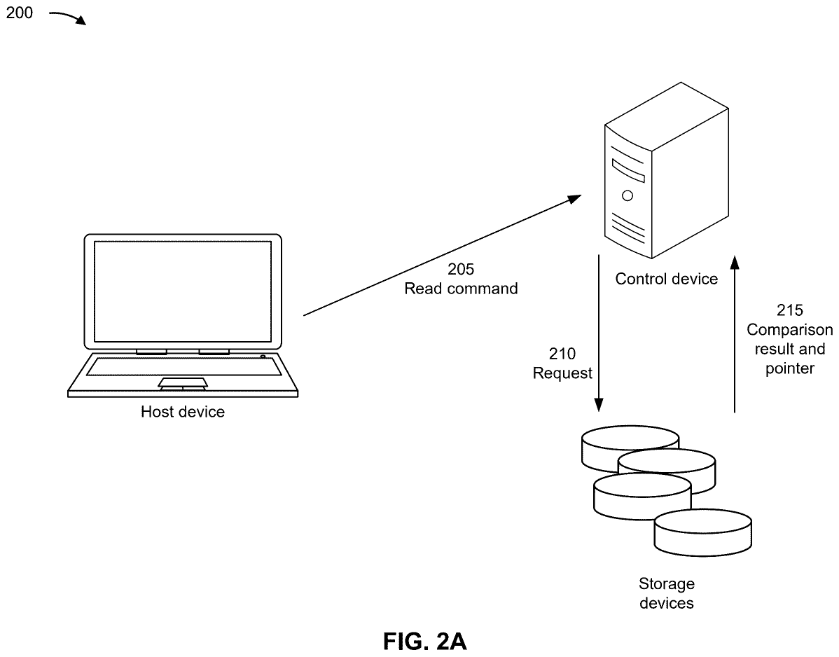

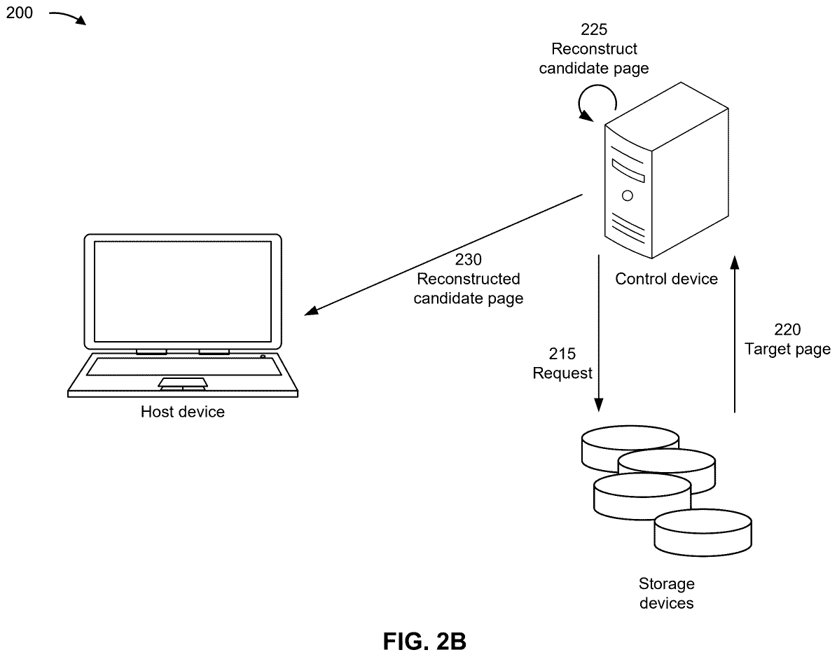

As shown by reference number 135, the control device may store (on the set of storage devices) the data structure along with a pointer to the target page. Accordingly, the control device may store (on the set of storage devices) the comparison result (e.g., the XOR result) along with the pointer. The pointer enables reconstruction of the candidate page during read operations (e.g., as described below in connection with FIGS. 2A-2B). In some implementations, as shown by reference number 140, the set of storage devices may transmit, and the control device may receive, confirmation that the data structure and the pointer were stored. The control device may forward the confirmation (e.g., directly or by re-encoding information from the confirmation received from the set of storage devices into a new message) to the host device. In examples where the control device uses an iterative process (e.g., as described in connection with FIG. 3) to continue matching target pages to candidate pages, the control device may continue to store comparison results (e.g., XOR results) with pointers for all candidate pages identified during the iterative process and for which associated comparison results satisfy the comparison threshold.

By using techniques as described in connection with FIGS. 1A-1C, memory overhead is reduced by storing the comparison result in lieu of a full copy of the candidate page. As indicated above, FIGS. 1A-1C are provided as an example. Other examples may differ from what is described with regard to FIGS. 1A-1C.

FIGS. 2A-2B are diagrams of an example 200 associated with storage optimization via data deduplication. As shown in FIGS. 2A-2B, example 200 includes a host device, a control device, and a set of storage devices. These devices are described in more detail in connection with FIGS. 4 and 5.

As shown in FIG. 2A and by reference number 205, the host device may transmit, and the control device may receive, a read command. The read command may be associated with a candidate page that is stored on the set of storage devices. For example, the read command may indicate the candidate page (e.g., using an index or another type of identifier). In some implementations, the host device may transmit the read command in response to input from a user. For example, the user may open a file, cut a file, and/or copy a file, among other examples. Therefore, the candidate page may represent file operations requested by the user. Additionally, or alternatively, the host device may transmit the read command automatically. For example, the host device may be configured to automatically index contents of the set of storage devices. Therefore, the candidate page may represent indexing operations and/or other automatic operations performed by the host device.

In response to the read command, the control device may retrieve a comparison result (e.g., an XOR result) that was compressed and stored (e.g., as described in connection with FIGS. 1B-1C) along with a pointer to a target page. For example, as shown by reference number 210, the control device may transmit, and the set of storage devices may receive, a request that indicates the candidate page. For example, the control device may transmit, and the set of storage devices may receive, the request using an API provided by the set of storage devices and/or a driver that controls the set of storage devices. As shown by reference number 215, the set of storage devices may transmit, and the control device may receive, the comparison result and the pointer in response to the request. For example, the set of storage devices may map an identifier of the candidate page (e.g., included in the request) to a data structure encoding the comparison result and the pointer.

Although the example 200 describes the control device as separate (e.g., logically, virtually, and/or physically) from the set of storage devices, other examples may have the control device at least partially integrated with the set of storage devices.

As shown in FIG. 2B, the control device may retrieve the target page using the pointer. For example, as shown by reference number 215, the control device may transmit, and the set of storage devices may receive, a request that indicates the target page. Accordingly, as shown by reference number 220, the set of storage devices may transmit, and the control device may receive, the target page in response to the request. Although the example 200 is described in connection with the control device requesting the target page, other examples may include the set of storage devices automatically retrieving the target page. For example, the set of storage devices may return the comparison result with the target page in response to a single request from the control device (e.g., based on processing the pointer automatically).

As shown by reference number 225, the control device may reconstruct the candidate page based on the comparison result and the pointer. For example, the control device may combine (the data structure encoding) the comparison result with the target page in order to reconstruct the candidate page. Although the example 200 is described in connection with the control device reconstructing the candidate page, other examples may include the set of storage devices automatically reconstructing the candidate page. For example, the set of storage devices may return a reconstructed version of the candidate page in response to a single request from the control device (e.g., based on generating the reconstructed version automatically).

As shown by reference number 230, the control device may transmit, and the host device may receive, the candidate page after reconstruction (e.g., the reconstructed version of the candidate page). The control device may return the candidate page after reconstruction in response to the read command. Therefore, space is conserved at the set of storage devices (e.g., by storing the comparison result and the pointer in lieu of a full copy of the candidate page) transparent to the host device.

As indicated above, FIGS. 2A-2B are provided as an example. Other examples may differ from what is described with regard to FIGS. 2A-2B.

FIG. 3 is a diagram of an example process 300 for iterating through pages for data deduplication. The example process 300 may be performed by a storage device, a host device, and/or a control device (e.g., as described in connection with FIGS. 1A-1C). These devices are described in more detail in connection with FIGS. 4 and 5.

As shown by block 305, the storage device may identify a target page (e.g., represented by T) for a source page (e.g., represented by S). For example, the storage device may compare hash values to select the target page for the source page.

As shown by block 310, the storage device may identify a neighbor target page (e.g., represented by T.i) for a neighbor source page (e.g., represented by S.i). For example, the storage device may identify neighbor pages with higher indices (e.g., where i+=1) and/or with lower indices (e.g., where i−=1).

As shown by block 315, the storage device may calculate an XOR result (e.g., represented by X.i) between the neighbor target page and the neighbor source page. The storage device may calculate the XOR result at a block level.

As shown by block 320, the storage device may determine a quantity of zeroes in the XOR result. For example, more zeroes in the XOR result may indicate greater similarity between the neighbor target page and the neighbor source page.

As shown by block 325, the storage device may determine if the quantity of zeroes satisfies a threshold. For example, the storage device may use a similarity threshold, as described in connection with FIG. 1B.

As shown by block 330a, the storage device may terminate searching when the quantity of zeroes fails to satisfy the threshold. On the other hand, as shown by block 330b, the storage device may save the XOR result (along with a point to the neighbor target page) when the quantity of zeroes satisfies the threshold. Additionally, as shown in FIG. 3, the storage device may iterate the search process. For example, the storage device may increment (or decrement) i and identify a new neighbor target page for a new neighbor source page. The storage device may continue iterating to find new target and source pages until the similarity threshold fails to be satisfied.

As indicated above, FIG. 3 is provided as an example. Other examples may differ from what is described with regard to FIG. 3.

FIG. 4 is a diagram of an example environment 400 in which systems and/or methods described herein may be implemented. As shown in FIG. 4, environment 400 may include a host device 410 and a control device 420 connected via a network (and/or bus) 430. Additionally, environment 400 may include a set of storage devices 440 (shown as storage device 440-1, storage device 440-2, and storage device 440-3 in FIG. 4) connected to the control device 420 via a network (and/or bus) 450.

The host device 410 may include one or more devices capable of receiving, generating, storing, processing, providing, and/or routing pages to and from the set of storage devices 440 (via the control device 420), as described elsewhere herein. The host device 410 may include a communication device and/or a computing device. For example, the host device 410 may include a server, such as an application server, a client server, a web server, a database server, a host server, a proxy server, a virtual server (e.g., executing on computing hardware), or a server in a cloud computing system. In some implementations, the host device 410 may include computing hardware used in a cloud computing environment. The host device 410 may execute an operating system (OS) that uses the set of storage devices 440.

The control device 420 may include one or more devices capable of receiving, generating, storing, processing, providing, and/or routing tracks for pages to and from the set of storage devices 440, as described elsewhere herein. The control device 420 may include a communication device and/or a computing device. For example, the control device 420 may include a server, a host server, a proxy server, a virtual server (e.g., executing on computing hardware), or a server in a cloud computing system.

The network and/or bus 430 may include one or more wired and/or wireless networks. For example, the network and/or bus 430 may include a wireless wide area network (e.g., a cellular network or a public land mobile network), a local area network (e.g., a wired local area network or a wireless local area network (WLAN), such as a Wi-Fi network), a personal area network (e.g., a Bluetooth® network), a near-field communication network, a telephone network, a private network, the Internet, and/or a combination of these or other types of networks. Additionally, or alternatively, the network and/or bus 430 may include an electrical connection (e.g., a wire, a trace, and/or a lead) and/or a wireless bus. The network and/or bus 430 may enable communications between the host device 410 and the control device 420.

Each storage device (e.g., the storage device 440-1, the storage device 440-2, or the storage device 440-3) may include one or more devices capable of receiving, generating, storing, processing, and/or providing information as pages, as described elsewhere herein. The storage devices 440 may include non-transitory computer-readable media. Although the example environment 400 includes three storage devices, other examples may include fewer storage devices (e.g., two storage devices) or additional storage devices (e.g., four storage devices, five storage devices, and so on).

The network and/or bus 450 may include one or more wired and/or wireless networks. For example, the network and/or bus 450 may include a wireless wide area network (e.g., a cellular network or a public land mobile network), a local area network (e.g., a wired local area network or a WLAN, such as a Wi-Fi network), a personal area network (e.g., a Bluetooth network), a near-field communication network, a telephone network, a private network, the Internet, and/or a combination of these or other types of networks. Additionally, or alternatively, the network and/or bus 450 may include an electrical connection (e.g., a wire, a trace, and/or a lead) and/or a wireless bus. The network and/or bus 450 may enable communications between the control device 420 and the storage devices 440.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

FIG. 5 is a diagram of example components of a device 500 associated with storage optimization via data deduplication. The device 500 may correspond to a host device 410, a control device 420, and/or a set of storage devices 440. In some implementations, a host device 410, a control device 420, and/or a set of storage devices 440 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

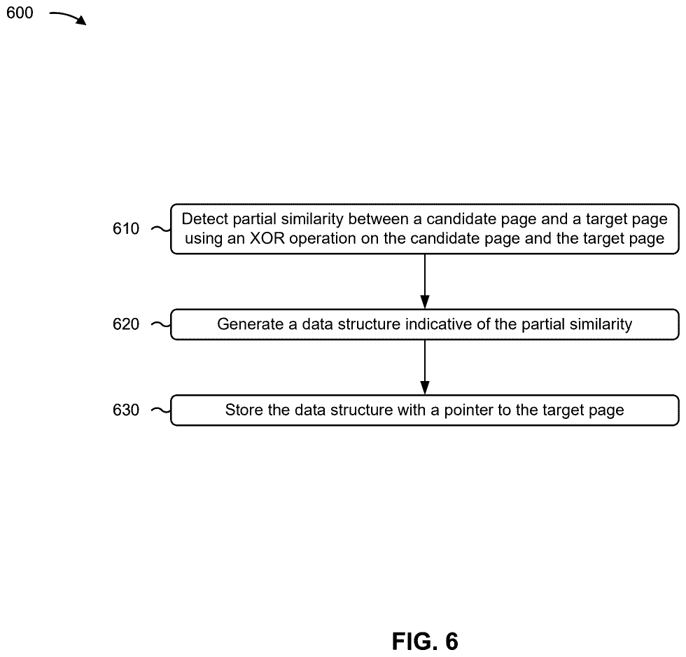

FIG. 6 is a flowchart of an example process 600 associated with storage optimization via data deduplication. In some implementations, one or more process blocks of FIG. 6 are performed by a storage device (e.g., storage device 440). In some implementations, one or more process blocks of FIG. 6 are performed by another device or a group of devices separate from or including the storage device, such as a host device 410 and/or a control device 420. Additionally, or alternatively, one or more process blocks of FIG. 6 may be performed by one or more components of device 500, such as processor 520, memory 530, input component 540, output component 550, and/or communication component 560.

As shown in FIG. 6, process 600 may include detecting partial similarity between a candidate storage page and a target storage page using an XOR operation on the candidate storage page and the target storage page (block 610). For example, the storage device may detect partial similarity between a candidate storage page and a target storage page using an XOR operation on the candidate storage page and the target storage page, as described herein.

As further shown in FIG. 6, process 600 may include generating a data structure indicative of the partial similarity (block 620). For example, the storage device may generate a data structure indicative of the partial similarity, as described herein.

As further shown in FIG. 6, process 600 may include storing the data structure with a pointer to the target storage page (block 630). For example, the storage device may store the data structure with a pointer to the target storage page, as described herein.

Process 600 may include additional implementations, such as any single implementation or any combination of implementations described below and/or in connection with one or more other processes described elsewhere herein.

In a first implementation, process 600 includes calculating a hash value of the candidate storage page, and selecting the target storage page using the hash value of the candidate storage page.

In a second implementation, alone or in combination with the first implementation, process 600 includes calculating a hash value of the target storage page, and comparing the hash value of the candidate storage page with the hash value of the target storage page.

In a third implementation, alone or in combination with one or more of the first and second implementations, selecting the target storage page includes identifying the target storage page based on the hash value of the target storage page matching the hash value of the candidate storage page.

In a fourth implementation, alone or in combination with one or more of the first through third implementations, detecting the partial similarity includes determining that a quantity of zero areas in results of the XOR operation satisfies a similarity threshold.

In a fifth implementation, alone or in combination with one or more of the first through fourth implementations, process 600 includes receiving a read command associated with the candidate storage page, and reconstructing, in response to the read command, the candidate storage page based on the data structure and the pointer.

In a sixth implementation, alone or in combination with one or more of the first through fifth implementations, process 600 includes returning the candidate storage page, after reconstruction, in response to the read command.

In a seventh implementation, alone or in combination with one or more of the first through sixth implementations, reconstructing the candidate storage page includes retrieving the target storage page using the pointer, and combining the data structure with the target storage page to reconstruct the candidate storage page.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations described herein to the precise forms that are described. Modifications and variations may be made in light of the above description or may be acquired from practice of the implementations described herein.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations described herein. Thus, the operation and behavior of the systems and/or methods are described herein without reference to specific software code—it being understood that software and hardware can be designed to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or described in the specification, these combinations are not intended to limit the implementations described herein. In fact, many of these features may be combined in ways not specifically recited in the claims and/or described in the specification. Although each dependent claim listed below may directly depend on only one claim, the description includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a component” or “one or more components” (or another element, such as “a processor” or “one or more processors”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items,), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method comprising:
detecting, by a storage device, partial similarity between a candidate storage page and a target storage page using an XOR operation on the candidate storage page and the target storage page,
wherein the target storage page is selected based on a comparison result related to the XOR operation satisfying a threshold, and
wherein the threshold is based on one or more properties of the storage device;
generating, by the storage device, a data structure indicative of the partial similarity;
storing, by the storage device, the data structure with a pointer to the target storage page;
receiving, by the storage device, a read command associated with the candidate storage page; and
reconstructing, by the storage device and in response to the read command, the candidate storage page based on the data structure and the pointer.

2. The method of claim 1, further comprising: calculating, by the storage device, a hash value of the candidate storage page; and
selecting, by the storage device, the target storage page using the hash value of the candidate storage page.

3. The method of claim 2, further comprising: calculating, by the storage device, a hash value of the target storage page; and
comparing, by the storage device, the hash value of the candidate storage page with the hash value of the target storage page.

4. The method of claim 3, wherein selecting the target storage page comprises:
identifying, by the storage device, the target storage page based on the hash value of the target storage page matching the hash value of the candidate storage page.

5. The method of claim 1, wherein detecting the partial similarity comprises:
determining, by the storage device, that a quantity of zero areas in results of the XOR operation satisfies a similarity threshold.

6. The method of claim 1, further comprising: returning, by the storage device, the candidate storage page, after reconstruction, in response to the read command.

7. The method of claim 1, wherein reconstructing the candidate storage page comprises:
retrieving, by the storage device, the target storage page using the pointer; and
combining, by the storage device, the data structure with the target storage page to reconstruct the candidate storage page.

8. A device comprising:
one or more processors configured to:
calculate a hash value for a candidate page to be stored;
compare the hash value of the candidate page with a set of hash values of a set of stored pages to identify a target page within the set of stored pages;
perform a set of XOR operations on the target page and one or more neighboring pages, relative to the candidate page, to determine a set of XOR results;
store a selected XOR result, from the set of XOR results, based on a similarity threshold,
wherein the threshold is based on one or more properties of a storage device for storing the selected XOR result; and
store a pointer to a selected page, from the target page and the one or more neighboring pages, with the selected XOR result,
wherein the selected page is selected based on the selected XOR result satisfying the similarity threshold.

9. The device of claim 8, wherein the set of XOR operations are performed at a block level.

10. The device of claim 8, wherein the similarity threshold is selected based on one or more properties of a storage system for the candidate page.

11. The device of claim 8, wherein the one or more processors are configured to:
receive a read command indicating the candidate page; and
retrieve the selected XOR result and the pointer to the selected page in response to the read command.

12. The device of claim 11, wherein the one or more processors are configured to:
retrieve the selected page using the pointer;
combine the selected XOR result with the selected page to reconstruct the candidate page; and
return the candidate page, after reconstruction, in response to the read command.

13. The device of claim 8, wherein, to compare the hash value of the candidate page with the set of hash values of the set of stored pages to identify the target page, the one or more processors are configured to: identify the target page based on the hash value of the candidate page matching a hash value, in the set of hash values, of the target page.

14. A non-transitory computer-readable medium storing a set of instructions, the set of instructions comprising:
one or more instructions that, when executed by one or more processors of a device, cause the device to:
perform a set of comparison operations between a set of target storage pages and a candidate storage page to determine a set of comparison results;
select a best target storage page, from the set of target storage pages, using the set of comparison results,
wherein the best target storage page is selected based on a corresponding comparison result, of the set of comparison results, satisfying a threshold, and
wherein the threshold is based on one or more properties of a storage device;
compress and store a comparison result, from the set of comparison results, corresponding to the best target storage page, to the storage device; and
store a pointer to the best target storage page to enable reconstruction of the candidate storage page during read operations.

15. The non-transitory computer-readable medium of claim 14, wherein the one or more instructions, when executed by the one or more processors, cause the device to:
receive a read command indicating the candidate storage page; and
retrieve the comparison result that was compressed and stored and the pointer to the best target storage page in response to the read command.

16. The non-transitory computer-readable medium of claim 15, wherein the one or more instructions, when executed by the one or more processors, cause the device to:
retrieve the best target storage page using the pointer;
combine the comparison result with the best target storage page to reconstruct the candidate storage page; and
return the candidate storage page, after reconstruction, in response to the read command.

17. The non-transitory computer-readable medium of claim 14, wherein the set of comparison operations comprises a set of XOR operations.

18. The non-transitory computer-readable medium of claim 14, wherein the one or more instructions, when executed by the one or more processors, cause the device to:
select the set of target storage pages using at least one hash value for at least one target storage page in the set of target storage pages.

19. The non-transitory computer-readable medium of claim 14, wherein the one or more instructions, to select the best target storage page using the set of comparison results, cause the device to:
select the best target storage page based on the comparison result corresponding to the best target storage page satisfying a similarity threshold.

20. The non-transitory computer-readable medium of claim 19, wherein the similarity threshold is selected based on one or more properties of a storage system for the candidate storage page.
